(19) United States
(12) Patent Application Publication
(10) Pub. No.: US 2006/0146686 A1
(43) Pub. Date: Jul. 6, 2006

(54) Method for securing content on a recording medium and a recording medium storing content secured by the method

(76) Inventors: Byung Jin Kim, Kyunggi-do (KR); Sung Wan Park, Suwon-si (KR)

Correspondence Address: HARNESS, DICKEY & PIERCE, P.L.C., P.O. BOX 8910, RESTON, VA, 20195, US

(21) Appl. No.: 11/298,650

(22) Filed: Dec. 12, 2005

Related U.S. Application Data
(60) Provisional application No. 60/634,999, filed on Dec. 13, 2004.

(30) Foreign Application Priority Data
Nov. 5, 2005 (KR) 10-2005-0105755

(51) Int. Cl. G11B 7/24

(52) U.S. Cl. 369/275.1

(57) ABSTRACT

The present invention relates to a method for securing content on a recording medium. Input content data are encrypted and recorded on a recording medium. A resultant value obtained by applying a hash function to the content data recorded after encryption is recorded on the recording medium for validation of the content. According to the present invention, once hashing operation for validation of content is carried out after encryption of content data is done, an apparatus for reproducing a recording medium storing content can easily check the validity of stored content by carrying out hashing operation only.

### PRIORITY INFORMATION

This application claims priority under 35 U.S.C. §119 on Korean Patent Application No. 10-2005-0105755, filed on Nov. 5, 2005, the entire contents of which are hereby incorporated by reference.

This application also claims priority under 35 U.S.C. §119 on U.S. Provisional Application No. 60/634,999, filed on Dec. 13, 2004, the entire contents of which are hereby incorporated by reference.

### BACKGROUND

1. Field of the Invention

The present document is related to a method for securing content on a read-only recording medium and a recording medium storing content secured by the method.

2. Description of the Related Art

DVD-ROM, called as DVD, provides a recording capacity of about 4.7 GBytes and therefore can store content such as movie with quality much better than that of TV signal; DVD is now being widely used.

Since current TV broadcast signal is being converted to digital form and digital TV broadcast signal provides superior quality to that of current analog signal, the user has a desire to obtain and watch a movie on a recording medium of higher quality than that provided by DVD.

On these grounds, a read-only disc having much higher capacity is being developed. Once a disc of high capacity is developed, high quality content can be recorded thereon and distributed; thus, users can easily enjoy high quality content.

However, as hard disks installed on PCs have become to have a large capacity and various multimedia playback programs have been distributed, when high quality content is recorded and distributed on a high capacity read-only disc, the recorded content may be duplicated to another recording medium by a disc copy apparatus and thus reproduced. In order to prevent such unauthorized duplication of content and watching, content data can be encrypted and thus recorded on a recording medium.

Encrypted keys, however, can also be read out illegally from the corresponding recording medium; therefore, it is still insufficient for securing recorded content.

### SUMMARY OF THE INVENTION

The present invention, therefore, is directed to provide a method for securing content by providing information to confirm authorization of content on a recording medium, thereby preventing unauthorized reproduction much more effectively.

Another objective of the present invention is to provide a method for securing content, the method enabling prompt validation for reproduction of provided content.

Also, another objective of the present invention is to provide a recording medium storing content, the data of which have been processed by a method for securing content, the method preventing unauthorized reproduction of content much more effectively and enabling prompt validation for reproduction.

To achieve the objectives above, a recording medium according to the present invention includes content data recorded after encryption and a resultant value obtained by applying a hash function to the encrypted content data.

A method for recording data on a recording medium according to the present invention is characterized in that input content data are encrypted and recorded on a recording medium; and a resultant value is recorded on the recording medium, the resultant value being obtained by applying a hash function to the content data recorded after encryption.

Also, a method for reproducing a recording medium according to the present invention is characterized in that a hash function is applied to content data recorded after encryption and validity of the recorded content data is determined according to a comparison result obtained by comparing a resultant value obtained by the above application with a hash result value recorded on the recording medium.

In one embodiment according to the present invention, a hash function is reapplied to a list of function values obtained by applying a hash function to each block unit dividing the content data recorded after encryption, the resultant value of which is used as a hash result value for determining said validity.

In another embodiment according to the present invention, a list of function values obtained by applying a hash function to each block unit dividing the content data recorded after encryption is used as a hash result value for determining said validity.

In one embodiment according to the present invention, data with electronic signature using public key of a content provider is added to a resultant value obtained by reapplying a hash function to the list of function values.

In one embodiment according to the present invention, when content data recorded on a recording medium is determined to be valid, decryption key for the content data is obtained from the recording medium or through network; the recorded content data are decoded by the obtained decryption key and decoded output is produced.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 illustrates, according to the present invention, the structure of a disc manufacturing apparatus for producing read-only recording media having information to check the validity of content data;

FIG. 2 illustrates data processing operations to secure recorded content according to one embodiment of the present invention; and

FIG. 3 illustrates the structure of one embodiment of an apparatus reproducing a read-only recording medium storing data-secured content according to the present invention.

### DETAILED DESCRIPTION OF THE PREFFERRED EMBODIMENT

Hereinafter, according to the present invention, preferred embodiments will be described in detail with reference to appended drawings.

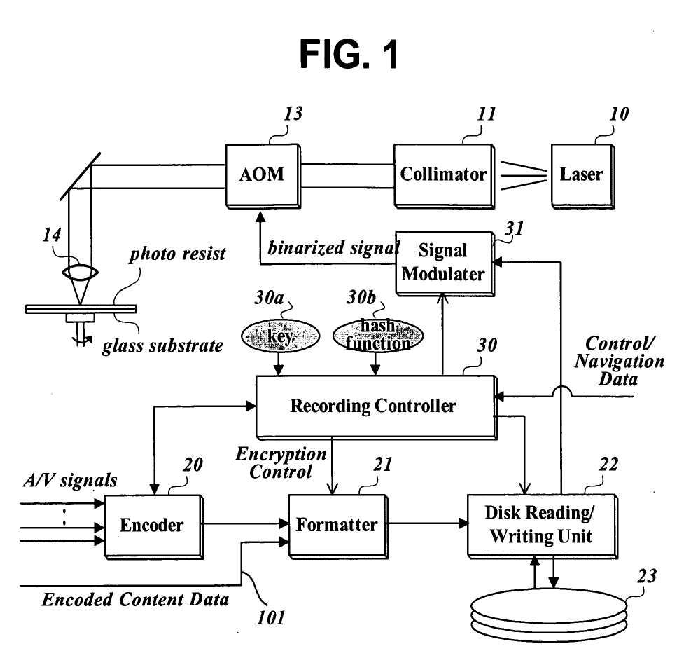

FIG. 1 illustrates the structure of an apparatus according to the present invention, the apparatus being for manufacturing read-only optical discs having information for checking validity, comprising: a laser diode 10 which generates laser beam; a collimator 11 which collimates the generated laser beam as a parallel beam; an optical modulator 13 which blocks or transmits the parallel beam according to input modulated signal, for example, according to the level of EFM signal; a condensing lens 14 which concentrates output light of the optical modulator 13 onto the surface of a sensitive layer such as photo resist on a glass negative; an encoder 20 which encodes input content data, for example, according to MPEG format; a formatter 21 which encrypts the encoded data according to given key value and configures the encrypted data in terms of ECC (Error Correction Code) block format for recording; a high capacity storing medium 23 such as hard disk drive (HDD) which stores data; a disk reading/writing unit 22 which records on and reads out from the storing medium 23; a signal modulator 31 which modulates data recorded on the storing medium 23 into binarized signal for disc recording such as EFM signal; and a data controller 30 which processes the user input, carries out operations for securing content, generates navigation data for content, and controls irradiation of beam on the sensitive layer.

In order to manufacture read-only discs by using an apparatus shown in FIG. 1, content data and associated navigation data, both being recorded on a read-only disc, are first stored in the storing medium 23. The data controller 30 carries out data processing operations for securing content, which are to be described later, upon the data stored in the above way. The data, where the processing operations have been applied, are read by control of the data controller 30 and modulated into binarized signal by the signal modulator 31; the modulated signal blocks or transmits output light of the optical modulator 13 according to the level thereof and forms pit trains at the sensitive layer on the glass negative according to the binarized signal. While pit trains are being formed, the condensing lens 14 gradually moves to outer circumference by the control of the data controller 30, thereby forming pit trains on the sensitive layer along spiral tracks. These pit trains are the data corresponding to content data and navigation data stored in the storing medium 23; a stamper is manufactured by using a sensitive layer wherein the pit trains are formed and read-only discs having navigation data according to the present invention are manufactured by using the stamper.

In other words, since content data where data processing for securing content has been applied and navigation data, which are recorded in the storing medium 23, are transcribed or wholly mapped onto a read-only disc through the procedure above, data structure recorded in the storing medium 23 and a data processing method for security are, namely, equivalent to recording on a read-only disc and processing data for security. Therefore, in the following, a method for recording data on the storing medium 23 and processing the data according to the present invention is described; but, the method can be equally applied to read-only discs.

First, input video signal is converted to a data stream being encoded in a particular format, for example, MPEG format by the encoder 20, configured in terms of ECC block by the formatter 21 and recorded on the storing medium 23 by the reading/writing unit 22. A data stream encoded in advance by a different apparatus can also be provided through another storing medium 101.

When the encoder 20 encodes data corresponding to content to be recorded, GOP is created, which is a set of pictures having I-picture as the head. The data controller 30 configures one or multiple GOPs having presentation time length of 0.4-1 second into a single navigation unit and generates navigation information for the unit. Necessary information for configuring by the navigation unit is received from the encoder 20. When content is recorded by the recording operations, video title set information (VTSI), which is management information needed, is generated and recorded as a single file, for example, with a filename of Video_TS.ifo. At this moment, necessary information for generating VTSI can be provided by the user through a menu based on GUI (Graphical User Interface) pre-programmed by the data controller 30. Since generation of management information including navigation data for recorded content does not have direct relevancy to the present invention, a further detailed explanation will be omitted.

As for the encoder 20 or encoded data provided by a separate storing medium 101, the formatter 21 encrypts encoded data based on encryption key 30a approved by the data controller 30 and configures the encrypted data to ECC blocks for recording, thereby making the ECC blocks being recorded on the storing medium 23 through the reading/writing unit 22. The encryption key used for the encryption procedure is one of commonly known methods and recorded or formed at a particular position of a read-only recording medium through the storing medium 23 or directly from stamper manufacturing procedure.

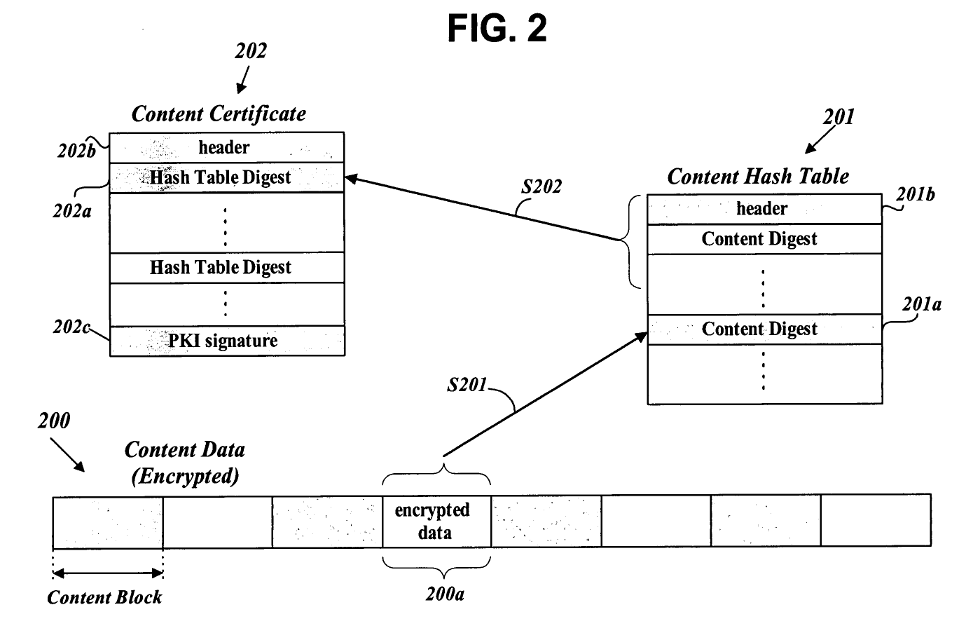

The data controller 30 carries out data processing operations for securing content data encrypted and recorded in a way described above. FIG. 2 illustrates data processing operations for securing recorded content according to one embodiment of the present invention.

The data controller 30 divides content data recorded after encryption 200 by block units of a fixed size, carries out hashing in order by sequentially reading each block through the reading/writing unit 22, generates a hash table 201, and records again the hash table on the storing medium 23 through the reading/writing unit 22. To explain by using one block as an example, for a selected content block 200a, a hash result 201a (hereinafter, it is also referred to as ‘content digest’) is obtained by feeding encrypted data within the block into a hash function 30b previously assigned S201. By applying such an operation to each block of recorded content 200 having encrypted data, a list of hash results, namely, hash table 201 is obtained.

Once a hash table 201 is obtained, necessary information for managing the table such as number of content digests, size of each digest (or position of each digest in the table) is created and recorded as header information 201b of the table. After a hash table 201 is completed in the above manner, the table is further divided by units of a fixed size and hashing is carried out for each unit S202. In other words, for each dividing unit, a hash result 202a (hereinafter, it is also referred to as ‘hash table digest’) is obtained by applying a pre-assigned hash function 30b (at this time, a function different from the hash function used for content data can be utilized); when hashing is completed for each dividing unit, information about number of hash table digests and so on is recorded as header information 202b. Finally, for a list of hash table digests generated in the above manner, electronic signing is carried out 202c by using public key assigned to a content provider, whereby a content certificate 202 is completed. The content certificate 202 completed in the above manner is recorded in the form of a file at a specified position within the storing medium 23 or with a specified name through the reading/writing unit 22; thus, data processing operations for securing recorded content, namely, a task for assigning validity to content recorded in a storing medium 23 is completed.

Through the procedure above, a recording medium storing content, the data of which has been processed for security, is manufactured.

Hereinafter, a procedure for reproducing a recording medium manufactured in the above manner is described.

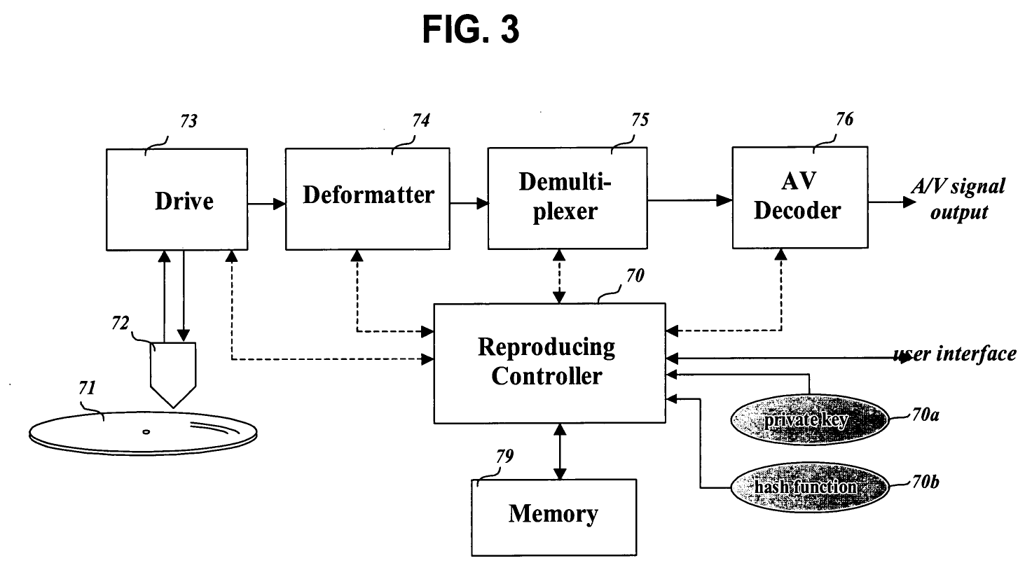

FIG. 3 illustrates the structure of one embodiment of an apparatus reproducing a read-only recording medium 71 storing content where a process for securing data has been applied according to the present invention. Upon a playback request, a reproducing controller 70 controls a drive 73 so that an optical pickup 72 first reads out a content certificate under the data structure as shown in FIG. 2. The playback request is realized by a user interface (operation buttons of a playback apparatus or remote control associated with the apparatus). User input can be specified, for example, through a menu based on GUI (Graphical User Interface) pre-programmed in the reproducing controller 70.

Error correction is applied to read-out data by a deformatter 74; A/V data is fed into a demultiplexer 75 and data other than A/V data (hash table data, navigation data and so on) are fed into the reproducing controller 70.

The reproducing controller 70, by using private keys of content providers 70a supplied by the content providers and pre-registered on internal memory, interprets the read-out content certificate. During this procedure, a player, having been manufactured illegally and thus, not having registered private keys of content providers, cannot interpret a content certificate stored on a loaded read-only medium.

Once the content of a content certificate is obtained being interpreted normally, the reproducing controller 70, identically to the previous content securing procedure for a recording medium, obtains a content hash table for stored content data 200 by hashing using a pre-stored hash function 70b and applies hashing again to the content hash table 201, thereby obtaining a content certificate and subsequently comparing with the content certificate interpreted previously. If the hash function 70b stored previously in the reproducing controller 70 were the same as a hash function with which a content provider had applied hashing to content, exactly the same certificate would be obtained.

If various content providers used a couple of separate hash functions, the reproducing controller 70 would accordingly prepare multiple hash functions. If a hashing result for stored content, namely, content certificate were not identical, the same procedure would be carried out by using another hash function. When the same hashing result was not obtained after all the registered hash functions having been tried, that is to say, when confirming validity of content fails, reproduction of content stored in a loaded recording medium is not carried out. Also, when a list 201 containing a hashing result or content certificate 202 does not exist in a loaded recording medium, reproduction of stored content is not carried out.

In the above procedure, when content certificates are identical, the reproducing controller 70 controls the drive 73 so that the optical pickup 72 reads out content data. The demultiplexer 75 reversely multiplexes an input data stream into encoded video/audio data; the A/V decoder 76 interprets input data—encrypted data—by using decryption key provided by the reproducing controller 70 and generates the original video/audio signal by decoding the decrypted A/V data.

During reproduction, operations of the deformatter 74, the demultiplexer 75, and the A/V decoder 76 are controlled by the reproducing controller 70. The decryption key is obtained by the recording medium 71 through one of commonly known methods. Alternatively, the decryption key can be received through a network from an external server associated with the content stored in the recording medium 71.

In another embodiment according to the present invention, only a content hash table is obtained by hashing content having encrypted data, whereas hashing for the hash table may not be carried out. In other words, as shown in FIG. 2, without creation of a content certificate 202, a content hash table 201 can provided being recorded along with content on a recording medium. At this time, the apparatus of FIG. 3, by a first hashing of content, can determine the validity of content stored in a loaded recording medium.

On the one hand, as described above, when hashing operation for determining validity of content is carried out after encryption of the content data, an apparatus for reproducing a recording medium storing the content can easily check the validity of the stored content by carrying out hashing operations only. In other words, validation of content can be realized independently of decryption procedure of content data.

On the other hand, when encryption of content data and recording thereof on a recording medium is carried out after hashing operation for securing validity of content, an apparatus for reproducing a recording medium storing content, in order to check the validity of the content, must first decrypt content data and compare the hashing result obtained by hashing of the decrypted data with a hash table or content certificate in the recording medium. Compared with the method described previously, it takes more time before actual reproduction of valid content is achieved. In addition, considering the fact that decryption procedure for encrypted data is typically carried out at A/V decoding stage, it is not desirable in terms of load since communications traffic between A/V decoder and reproducing controller takes place even for checking validity only.

According to a data processing method for securing content after encryption, since checking validity of content data is not accompanied by data decryption procedure at all, the method is more advantageous in the aspects of validation time and effective use of resources.

The present invention described with limited embodiments above, enables reproduction of authorized content (validity checked content) only by carrying out hashing for securing content stored in a read-only recording medium; furthermore, decision about authorization of content, namely, validation is carried out independently of encryption, whereby reproduction or denial of reproduction is made quickly. Therefore, user convenience and function for protecting copyright of a content provider are enhanced.

The foregoing description of a preferred embodiment of the present invention has been presented for purposes of illustration. Thus, those skilled in the art may utilize the invention and various embodiments with improvements, modifications, substitutions, or additions within the spirit and scope of the invention as defined by the following appended claims.

What is claimed is:

1. A recording medium storing data, the data comprising:
encrypted content data; and
a resultant value obtained by applying a hash function to the encrypted content data.

2. The recording medium of claim 1, wherein the resultant value includes a function value obtained by reapplying a hash function to a list of function values obtained from application of a hash function to each block unit that is divided from the encrypted content data.

3. The recording medium of claim 1, wherein the resultant value includes a list of function values obtained by applying a hash function to each block unit that is divided from the encrypted content data.

4. The recording medium of claim 1, wherein the recording medium is a read-only recording medium.

5. A method for recording data on a recording medium, comprising:
encrypting input content data and recording the encrypted data on the recording medium; and
recording a value on the recording medium, the value being obtained by applying a hash function to the encrypted content data.

6. The method of claim 5, wherein the value is a resultant value obtained by reapplying a hash function to a list of function values obtained from application of a hash function to each block unit that is divided from the encrypted content data.

7. The method of claim 5, wherein the value is a list of resultant values obtained by applying a hash function to each block unit that is divided from the encrypted content data.

8. The method of claim 5, wherein the recording medium is a read-only recording medium.

9. A method for reproducing encrypted content data recorded on a recording medium, comprising:
applying a hash function to the encrypted content data recorded; and
comparing a resultant value obtained from said applying step with information recorded on the recording medium, and determining validity of the recorded content data based on the comparison.

10. The method of claim 9, wherein the applying step reapplies a hash function to a list of function values obtained from application of a hash function to each block unit that is divided from the encrypted content data; and
wherein the information is a function value obtained by reapplying a hash function to a list of function values obtained from application of a hash function to each block unit that is divided from the encrypted content data.

11. The method of claim 9, wherein the applying step applies a hash function to each block unit that is divided from the encrypted content data recorded; and
wherein the information is a list of function values obtained from application of a hash function to each block unit that is divided from the encrypted content data.

12. The method of claim 9, further comprising:
obtaining a decryption key for the content data recorded after encryption if validity is confirmed at the determination, and using the obtained decryption key to decrypt the encrypted content data.

13. The method of claim 12, wherein the decryption key is obtained from the recording medium or from an external server through a network.
